(19) United States
(12) Patent Application Publication
(10) Pub. No.: US 2026/0204491 A1
(43) Pub. Date: Jul. 16, 2026

(54) CONTACT BRIDGE ARRANGEMENT AND SWITCHING DEVICE WITH FIXED CONTACTS ARRANGED BETWEEN TWO CONTACT BRIDGES

(71) Applicant: TE Connectivity Solutions GmbH, Schaffhausen (CH)

(72) Inventors: Thomas HAEHNEL, Schaffhausen (CH); Hicham NIKIBOU, Schaffhausen (CH)

(21) Appl. No.: 19/443,894

(22) Filed: Jan. 8, 2026

(30) Foreign Application Priority Data
Jan. 10, 2025 (DE) 102025100797.7

(51) Int. Cl. H01H 1/20

(52) U.S. Cl. CPC H01H 1/20

(57) ABSTRACT

A contact bridge arrangement for a switching device includes a first contact bridge movable along a switching direction between open and closed positions having a section for connecting to a drive system and at least two switching contacts and a second contact bridge with at least two auxiliary switching contacts. Two fixed-contact assemblies are provided which are located in the switching direction between the first and the second contact bridge, where each of the two fixed-contact assemblies comprises at least one fixed contact for contacting a switching contact and at least one fixed contact for contacting an auxiliary switching contact. In the open position, the fixed contacts, the switching contacts and the auxiliary switching contacts are disengaged from each other. In the closed position, the arrangement generates a magnetic force that presses the contacts together and counteracts a repulsion force acting between these contacts in the event of a short circuit.

### CROSS REFERENCE TO RELATED APPLICATIONS

This application claims the benefit of DE Application No. 102025100797.7, filed 10 Jan. 2025, the subject matter of which is herein incorporated by reference in its entirety.

### BACKGROUND OF THE INVENTION

The subject matter herein relates to a contact bridge arrangement and a switching device with such a contact bridge arrangement.

Contact bridge assemblies are used in switching devices, for example, relays or contactors, to open or close electrical circuits. In a closed circuit, the fixed contacts and the switching contacts are in contact with one another. In an open circuit, the switching contacts are moved away from the fixed contacts. A magnetic drive, which operates against a return spring, is typically used as the drive moving the switching contacts in such switching devices.

A short circuit event is problematic in such switching devices. Short-circuit currents in electric vehicles can reach 27 kA and more. At these currents, such high forces are generated at the contacts of the contact bridge assemblies that the switching contacts are moved away from the fixed contacts before short-circuit protection devices activate. The resulting electric arc can destroy the switching device. Therefore, the contacts must not be allowed to separate from one another in the event of a short circuit.

There is therefore a need for contact bridge assemblies in which the contacts remain in contact even in the event of a short circuit, so that no arcing occurs.

### BRIEF DESCRIPTION OF THE INVENTION

One solution is to provide a contact bridge arrangement for a switching device, such as a relay or contactor, in particular in electric vehicles, which comprises the following features: a first contact bridge comprising a section for connecting to a drive system, a first switching contact and a second switching contact, wherein the first switching contact and the second switching contact are spaced from one another, and wherein the first contact bridge is movable along a switching direction between an open position and a closed position; a second contact bridge comprising a first auxiliary switching contact and a second auxiliary switching contact, wherein the first auxiliary switching contact and the second auxiliary switching contact are spaced from one another; a first fixed-contact arrangement which is disposed in the switching direction between the first and the second contact bridge and comprises a proximal fixed contact for contacting the first switching contact as well as a distal fixed contact for contacting the first auxiliary switching contact; a second fixed-contact arrangement which is disposed in the switching direction between the first and the second contact bridge and comprises a proximal fixed contact for contacting the second switching contact as well as a distal fixed contact for contacting the second auxiliary switching contact; where, in the open position, the first switching contact is disengaged from the proximal fixed contact of the first fixed-contact arrangement, the distal fixed contact of the first fixed-contact arrangement is disengaged from the first auxiliary switching contact, the second switching contact is disengaged from the proximal fixed contact of the second fixed-contact arrangement, and the distal fixed contact of the second fixed-contact arrangement is disengaged from the second auxiliary switching contact; wherein, in the closed position, the first switching contact abuts the proximal fixed contact of the first fixed-contact arrangement, the distal fixed contact of the first fixed-contact arrangement abuts the first auxiliary switching contact, the second switching contact abuts the proximal fixed contact of the second fixed-contact arrangement, and the distal fixed contact of the second fixed-contact arrangement abuts the second auxiliary switching contact.

This solution prevents the switching contacts from disengaging from the fixed contacts in the event of a short circuit.

By using two contact bridges, a magnetic force generated by the short-circuit current acts in the direction toward the contact bridges in the event of a short circuit. In the event of a short circuit, this magnetic force counteracts the force that pushes the contacts apart.

Due to this effect, the drive system can be designed in a simpler manner as it no longer needs to be designed to absorb and compensate for the entire repulsion force occurring in the event of a short circuit between the contacts lying on top of one another. A welcome side effect of this design is that the two contact bridges reduce the current-conducting cross-section and thus the line resistance.

Another solution relates to a switching device, such as a relay or contactor, in particular for electric vehicles, which comprises such a contact arrangement.

Further developments of the solution described above shall be explained in more detail hereafter. The further developed features described there are advantageous independently of one another and can be combined as desired. Unless a distinction between the first and the second switching contact is crucial for the individual case, merely the term “switching contact” is used. The same applies to the first and the second auxiliary switching contact which are then generally referred to as “auxiliary switching contact.” If the distinction between the proximal and the distal fixed contact is irrelevant, merely the term “fixed contact” is used. Finally, if the distinction between switching contacts, auxiliary switching contacts, and/or fixed contacts is immaterial, the term “contact” is used.

The first and the second contact bridge can be formed to be identical in one configuration, which reduces the number of parts and the manufacturing costs.

The direction in which the first switching contact is spaced from the second switching contact is referred to hereinafter as the longitudinal direction. In one configuration, the longitudinal direction extends perpendicular to the switching direction. The first auxiliary switching contact can also be spaced from the second auxiliary switching contact in or parallel to the longitudinal direction, so that the distances, firstly, between the first and the second switching contact and, secondly, between the first and second auxiliary switching contact extend parallel to one another. However, such a parallel extension is not mandatory so that the direction in which the first auxiliary switching contact is spaced from the second auxiliary switching contact also does not necessarily have to extend parallel to the longitudinal direction.

In one configuration, the material of the first contact bridge can extend continuously in the longitudinal direction from the first switching contact to the second switching contact. Similarly, in another configuration, the material of the second contact bridge can extend continuously from the first auxiliary switching contact to the second auxiliary switching contact, in particular in the longitudinal direction. Each of these two configurations enables a short, straight-lined, and therefore low-loss current path directly from the first to the second switching contact or from the first to the second auxiliary switching contact, respectively.

In a further configuration, the first contact bridge can extend in a straight line from the first to the second switching contact. Alternatively or cumulatively, the second contact bridge can extend in a straight line from the first to the second switching contact. The first and/or the second contact bridge can each be formed to be elongated transverse to the switching direction, in particular in the longitudinal direction. In one configuration, the first and/or the second contact bridge can be configured, for example, as a beam or an elongated plate. The contact bridge can be manufactured from sheet metal, in particular by punching.

The one of the two fixed-contact assemblies, for example, the first one, can be located at the one end of the first and/or the second contact bridge disposed in the longitudinal direction, and the other one, for example, the second one, of the two fixed-contact assemblies can be located at the other end of the first and/or second contact bridge disposed in the longitudinal direction.

According to one configuration, the first and the second contact bridge are aligned parallel to one another, at least in the closed position, or the contact bridges extend parallel to one another, respectively. The first and the second contact bridge can therefore extend parallel to one another already when the first and the second auxiliary switching contact are spaced from one another in the longitudinal direction or parallel to the longitudinal direction, respectively. In a further configuration, the contact bridges can extend parallel to one another at least when a line extending in the longitudinal direction and connecting the first and second switching contact lies entirely within the material of the first contact bridge, and a line extending parallel to the longitudinal direction and connecting the first and the second auxiliary switching contact lies entirely within the material of the second contact bridge.

In order for the magnetic force pressing the contacts against one another in the event of a short circuit to be sufficiently large, the first and the second contact bridge should be connected to one another in an electrically conductive manner in the closed position, where the current flowing through the first and the second contact bridge in the closed position should flow in the same direction.

For example, in one configuration, the contact bridge arrangement in the closed position can form a continuous current path which extends from the first switching contact to the second switching contact, wherein the current path comprises a first branch extending through the first contact bridge and a second branch extending through the second contact bridge, wherein the first branch and the second branch extend parallel to one another and in the same direction. According to one configuration, the first branch extends from the first switching contact across the first contact bridge to the second switching contact and the second branch extends from the first auxiliary switching contact across the second contact bridge to the second auxiliary switching contact. These two branches generate the magnetic force that is in the opposite direction to the disengagement of the contacts in the event of a short circuit. To be able to accurately calculate this force, the current path in the first and the second contact bridge should preferably be straight-lined.

The first and second switching contacts can each be disposed at ends of the first contact bridge disposed in the longitudinal direction, for example, the first switching contact at the one end and the second switching contact at the other end disposed in the longitudinal direction. Regardless of that, the auxiliary switching contacts can be disposed at the ends of the second contact bridge disposed in the longitudinal direction, for example, the first auxiliary switching contact at the one end and the second auxiliary switching contact at the other end disposed in the longitudinal direction.

The first and the second fixed-contact arrangement can be spaced from one another in the longitudinal direction of the contact bridges.

Furthermore, the first and/or the second fixed-contact arrangement can have two sides that face away from one another and are oppositely disposed with respect to the switching direction. For example, the first side is disposed opposite the (first or second) switching contact, and the second side is disposed opposite the (first or second) auxiliary switching contact.

The proximal fixed contact of the first and/or the second fixed-contact arrangement is disposed, for example, on the first side, and the distal fixed contact of the first and/or the second fixed-contact arrangement is disposed, for example, on the second side of the respective fixed-contact arrangement. This results in a in particular simple configuration of the fixed-contact assemblies. The configuration can be further simplified if the proximal and the distal fixed contacts of the first fixed-contact arrangement and/or the proximal and distal fixed contact of the second fixed-contact arrangement are formed to be monolithic, i.e., formed by a single continuous body.

In one configuration, the second contact bridge can be stationary or fixed to the housing, which reduces the effort required for design and manufacturing.

However, to allow for the largest possible distances between the fixed contacts, the switching contacts, and the auxiliary switching contacts in the open position, the second contact bridge can alternatively be movable, in particular be driven along the switching direction.

For example, the second contact bridge can comprise a section for connecting to the drive system of the switching device. The drive system can comprise a common drive for the first and the second contact bridge or two separate drives, in particular independently controllable drives, one for each contact bridge. In one configuration, the first and the second contact bridge move toward one another during the transition from the open position to the closed position and away from one another during the transition from the closed position to the open position.

In an advantageous configuration, the two fixed-contact assemblies are formed by two separate components spaced from one another transverse to the switching direction. Each fixed-contact arrangement can be connected, for example, to a different externally accessible terminal of the switching device.

A short current path in the closed position is obtained if the proximal fixed contact of the first fixed-contact arrangement overlaps or aligns with the first switching contact along the switching direction. Furthermore, the distal fixed contact of the first fixed-contact arrangement can overlap or align with the first auxiliary switching contact along the switching direction. Likewise, the proximal fixed contact of the second fixed-contact arrangement can overlap or align with the second switching contact along the switching direction. Finally, the distal fixed contact of the second fixed-contact arrangement can overlap or align with the second auxiliary switching contact along the switching direction. The proximal fixed contact of the first fixed-contact arrangement can align with the distal fixed contact of the first fixed-contact arrangement along the switching direction, and the proximal fixed contact of the second fixed-contact arrangement can align with the distal fixed contact of the second fixed-contact arrangement along the switching direction.

To obtain a particularly short current path in the closed position, the first switching contact and the first auxiliary switching contact and/or the second switching contact and the second auxiliary switching contact can be arranged in alignment with one another in the switching direction, at least in the closed position.

According to one embodiment, the first and the second fixed-contact arrangement can be formed to be identical, which reduces manufacturing costs. The first and the second fixed-contact arrangement can be facing one another, in particular symmetrically, transverse to the switching direction with respect to the first and/or the second contact bridge.

In the closed position, the first switching contact can be contacted by several proximal fixed contacts of the first fixed-contact arrangement and/or the second switching contact can be contacted by several proximal fixed contacts of the second fixed-contact arrangement. Conversely however, a single proximal fixed contact of the first fixed-contact arrangement can also be contacted by several first switching contacts, or a single proximal fixed contact of the second fixed-contact arrangement can be contacted by several second switching contacts.

The same applies to the auxiliary switching contacts: In the closed position, the first auxiliary switching contact can be contacted by a plurality of distal fixed contacts of the first fixed-contact arrangement, or a single distal fixed contact of the first fixed-contact arrangement can be contacted by a plurality of first auxiliary switching contacts. In the closed position, the second auxiliary switching contact can be contacted by a plurality of distal fixed contacts of the second fixed-contact arrangement, or a single distal fixed contact of the second fixed-contact arrangement can be contacted by a plurality of second auxiliary switching contacts.

Each of these arrangements creates a larger contact area and thereby lower contact resistance between the contacts that are in contact with one another in the closed position. In the context presently described, the term “first switching contact” also comprises an arrangement or array of several first switching contacts, the term “second switching contact” also comprises an arrangement or array of several second switching contacts, the term “first auxiliary switching contact” also comprises an arrangement or array of several first auxiliary switching contacts, and the term “second auxiliary switching contact” also comprises an arrangement or array of several second auxiliary switching contacts.

A configuration can provide that the first one comprises more than one proximal fixed contact and/or more than one distal fixed contact. Alternatively or cumulatively, the second fixed-contact arrangement can have more than one proximal fixed contact and/or more than one distal fixed contact. In one configuration, this number can be, for example, equal to the number of proximal and distal fixed contacts of the second fixed-contact arrangement.

The first and/or the second fixed-contact arrangement can comprise at least one spring arm that is resiliently deflectable along the switching direction and that extends between the first and the second contact bridges and comprises at least one proximal fixed contact and/or at least one distal fixed contact. In one configuration, the at least one distal and/or the at least one proximal fixed contact is located at a free end of the spring arm that projects between the first and the second contact bridge. For example, positional tolerances in the closed position can be compensated for with the aid of such a spring arm.

According to one configuration, the spring arm is resiliently deflected in the closed position along the switching direction relative to the open position. With this configuration, it is not necessary to configure the second contact bridge to be movable along the switching direction, since the spring arm is pressed by the first contact bridge against the second contact bridge. In this configuration, the spring arm returns, for example, automatically to the open position. In the open position, the spring arm can be in particular force-free.

Each of the spring arms can comprise one or more proximal and/or distal fixed contacts. However, each spring arm preferably comprises only one proximal fixed contact and only one distal fixed contact. This arrangement allows for the best tolerance compensation. Each spring arm in the closed position can thereby be in electrical contact with exactly one (first or second) switching contact and exactly one (correspondingly also first or second) auxiliary switching contact.

The proximal and distal fixed contacts of a fixed contact arrangement, i.e., of the first or the second solid state arrangement, can all be electrically connected to one another. Alternatively, the proximal and the distal fixed contacts of a solid state arrangement can also be arranged to be electrically insulated from one another within the respective solid state arrangement.

If the first or the second fixed-contact arrangement comprises a plurality of proximal and/or distal fixed contacts, it can comprise multiple spring arms.

The at least one spring arm of the first fixed-contact arrangement is thereby disposed in a direction transverse to the switching direction opposite the at least one spring arm of the second fixed-contact arrangement. In the direction transverse to the switching direction, the spring arms can extend beyond the first and second contact bridge. The at least one spring arm of the first fixed-contact arrangement can extend parallel to the at least one spring arm of the second fixed-contact arrangement. In particular, the spring arms can extend in a direction toward one another. In the closed position and/or the open position, the spring arms can extend parallel to the contact bridges. All spring arms of the first and/or the second fixed-contact arrangement can be disposed in the same plane and/or be aligned parallel to one another, at least in the closed position and/or the open position.

Another advantageous configuration provides that a spring arm is configured multi-layered, i.e., it is composed of several, in particular at least two, layers. The layers can be layered onto each other in or transversed to the switching direction.

In such a configuration, the individual layers can fulfill different functions. For example, one layer can primarily serve as a conductor and the other primarily as a spring.

At least one layer of a spring arm can then form a leaf spring, while at least one other layer forms a conductor. The layer forming the conductor can be carried or supported by the layer forming the spring. The layer forming the spring can have a higher spring resilience than the layer forming the conductor.

To improve the functional separation between the current-conducting layer and the resilient layer, the layer forming the conductor can have a decoupling structure, for example, in the form of an arc or kink pointing away from the layer forming the spring, which reduces the spring effect of the current-conducting layer. The decoupling section decouples the resilient properties of the current-conducting layer from the resilient properties of the resilient layer. The current-conducting cross-section of the layer forming the conductor can remain uniform across the decoupling structure, so that no changes in resistance arise along the layer.

The layers of a spring arm can be constructed from different materials, in particular metallic materials, and/or form the same material which is processed and/or treated differently in the two layers. At least one layer contains or consists of, for example, copper. Alternatively or cumulatively, at least one layer contains or consists of chromium and/or nickel. A copper layer has low electrical resistance and can serve as a conductor, while a layer made of or containing chromium and/or nickel exhibits good spring properties.

However, at least one of the spring arms can also be made of a single layer of a single material, for example, a material containing aluminum or copper with sufficiently good spring properties and sufficient fatigue strength.

If a fixed-contact arrangement comprises spring arms, then they can extend in the longitudinal direction of the first and/or the second contact bridge between the contact bridges. With this configuration, the switching device can be built to be very flat. On the other hand, if the switching device is to be configured to be as compact as possible in the longitudinal direction of the first and/or the second contact bridge, the spring arms can also extend transverse to the switching direction and transverse to the longitudinal direction of the contact bridges between the first and the second contact bridge.

The contact arrangement can comprise blow magnets that generate a magnetic field which extends at the switching and auxiliary switching contacts along the longitudinal direction of the contact bridges.

A switching device that comprises a contact bridge arrangement in one of the above-mentioned configurations can be provided with a drive system that is connected to the first contact bridge and configured to move the first contact bridge along the switching direction between the open position and the closed position.

In a further configuration, the drive system can also be connected to the second contact bridge and configured to move the second contact bridge along the switching direction between the open position and the closed position.

In the latter configuration, the direction of motion of the first contact bridge from the open position to the closed position can be opposite to the direction of motion of the second contact bridge from the open position to the closed position.

The use of two driven contact bridges has the advantage over a single driven contact bridge that, in the open position, a larger spacing can be obtained between, firstly, the switching contact and the fixed contact disposed opposite in the switching direction, and, secondly, between the auxiliary switching contact and the fixed contact disposed opposite in the switching direction. In addition, spring arms can be omitted, thus simplifying the configuration of the switching device.

Nevertheless, even when using two driven contact bridges, it can be advantageous to provide at least one resiliently deflectable spring arm for the fixed contacts, as described above, since the resilience of the spring arms allows for tolerance compensation.

However, the use of spring arms generally requires a higher drive force on the part of the drive system for deflecting the spring arms.

The first contact bridge can be driven independently of the second contact bridge. For example, the drive system can comprise a first drive unit for driving the first contact bridge and a second drive unit which can be actuated independently of the first drive unit for driving the first contact bridge. A drive unit could be, for example, a solenoid.

Alternatively, the first and the second contact bridge can be driven jointly by the drive system. In such a configuration, the first and the second contact bridge can be mechanically coupled to one another.

The switching device can also comprise at least one overtravel spring. The first contact bridge can comprise an overtravel spring, and the second contact bridge can likewise comprise an overtravel spring. An overtravel spring is preferably arranged between the drive system and the first and/or the second contact bridge.

Furthermore, the first and/or the second contact bridge can be held to be movable in a holder along the switching direction against the action of the overtravel spring. The holder can be, in particular, cage-shaped. The first and/or the second contact bridge in the open position can be, in particular, pressed against the holder by the overtravel spring. The overtravel spring in the closed position can be deflected relative to the open position, and the first and/or the second contact bridge associated with the overtravel spring can be displaced in the holder along the switching direction in the closed position relative to the open position

In the following, the invention shall be explained in more detail by way of example using embodiments with reference to the appended drawings. Features not present in the embodiment illustrated and described can be added in accordance with the above explanations. Conversely, features present in the embodiment illustrated and described can also be omitted in accordance with the above explanations.

### BRIEF DESCRIPTION OF THE DRAWINGS

For the sake of simplicity, the same reference numerals shall be used hereafter in the figures for elements that correspond to one another in terms of function and/or structure, where:

FIG. 1 shows a schematic perspective illustration of a switching device with a contact bridge arrangement;

FIG. 2 shows a schematic perspective illustration of a fixed-contact arrangement;

FIG. 3 shows a schematic side view of a contact arrangement in the closed position;

FIG. 4 shows a schematic illustration of a further configuration of a contact arrangement or switching device in the closed position;

FIG. 5 shows a view along line V-V of FIG. 4;

FIG. 6 shows a schematic illustration of the contact arrangement or switching device of FIG. 4 in the open position;

FIG. 7 shows the view along line VII-VII of FIG. 6.

### DETAILED DESCRIPTION OF THE INVENTION

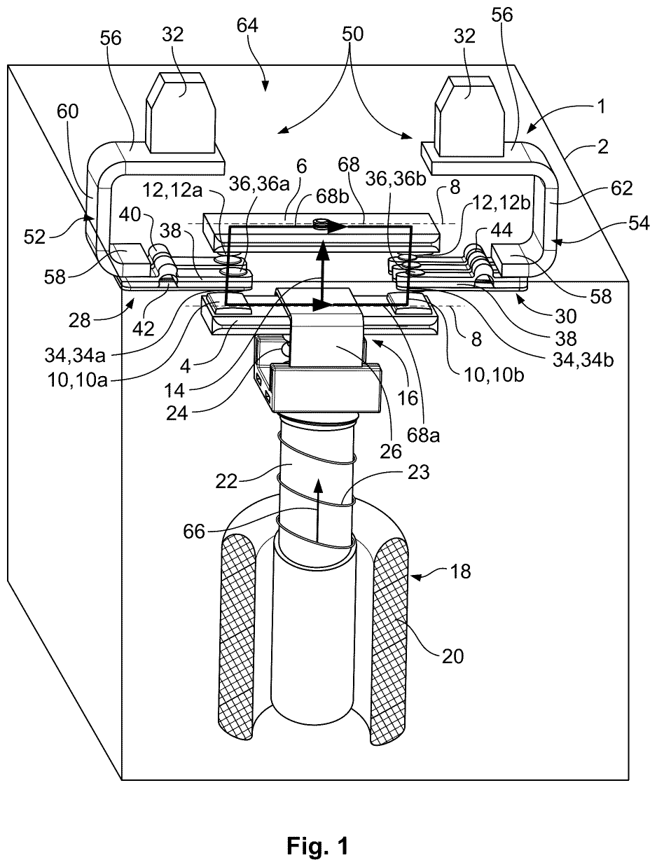

FIG. 1 shows a contact arrangement 1 of a switching device 2, for example, a relay or a contactor, in particular for electric vehicles. Switching device 2 is only indicated in FIG. 1.

The contact arrangement comprises a first contact bridge 4 and a second contact bridge 6. As shown, two contact bridges 4 and 6 can be formed to be identical.

First contact bridge 4 comprises two switching contacts 10 that are spaced from one another in longitudinal direction 8, a first switching contact 10a and a second switching contact 10b. Second contact bridge 6 comprises two auxiliary switching contacts 12 that are spaced from one another in longitudinal direction 8, a first auxiliary switching contact 12a and a second auxiliary switching contact 12b. Both contact bridges 4 and 6 are made of electrically conductive material, allowing current to flow from one contact 10 or 12 to the respective other corresponding contact.

First switching contact 10a is spaced in longitudinal direction 8 from second switching contact 10b. In the embodiment illustrated, first auxiliary switching contact 12a is also spaced in longitudinal direction 8 from second auxiliary switching contact 12b. This already results in two contact bridges 4 and 6 having a parallel extension to each other.

Furthermore, first contact bridge 4, or the material of first contact bridge 4, respectively, can extend continuously in longitudinal direction 8 from first switching contact 10a to second switching contact 10b, and/or second contact bridge 6, or the material of second contact bridge 6, respectively, can extend continuously in longitudinal direction 8 from first auxiliary switching contact 12a to second auxiliary switching contact 12b. This is also an example of a parallel extension of first and second contact bridge 4, 6.

First contact bridge 4 can extend in a straight line, in particular as shown, along longitudinal direction 8 from first switching contact 10a to second switching contact 10b. Second contact bridge 6 can likewise extend in a straight line, as likewise shown, along longitudinal direction 8 from first auxiliary switching contact 10a to second auxiliary switching contact 10b. For example, first contact bridge 4 and/or second contact bridge 6 can be configured in the form of a beam or in the form of plate.

First contact bridge 4 is movable along a switching direction 14. It comprises a section 16 for connecting to a drive system 18 which is presently likewise shown only schematically. Drive system 18 comprises, for example, an electric magnet 20 that drives a plunger 22 along switching direction 14 against the action of a return spring 23 fixed at one end to the housing. First contact bridge 4 is pressed by an overtravel spring 24 toward second contact bridge 6 against a holder 26 that presently engages around the first contact bridge in a bracket shape. First contact bridge 4 can be moved away from holder 26 along switching direction 14 against the action of overtravel spring 24.

Disposed along switching direction 14 between first contact bridge 4 and second contact bridge 6 is a first fixed-contact arrangement 28 and a second fixed-contact arrangement 30.

First fixed-contact arrangement 28 is spaced in longitudinal direction 8 from second fixed-contact arrangement 30. Fixed-contact assemblies 28, 30 can each be connected to a terminal 32 of switching device 2. Terminals 32 connect contact arrangement 1 or switching device 2, respectively, to a circuit to be switched.

Both fixed-contact assemblies 28, 30 each comprise at least one proximal fixed contact 34, each for contacting a switching contact 10, and at least one distal fixed contact 36 for contacting an auxiliary switching contact 12. Proximal fixed contact 34a of first fixed-contact arrangement 28 is configured to contact first switching contact 10a, while distal fixed contact 36a of first fixed-contact arrangement 28 is configured to contact first auxiliary switching contact 12a. Proximal fixed contact 34b of second fixed-contact arrangement 28 is configured to contact second switching contact 10b, while distal fixed contact 36b of second fixed-contact arrangement 30 is configured to contact second auxiliary switching contact 12b.

Disposed along switching direction 14 are distal fixed contacts 36a, 36b directly opposite their respective associated auxiliary switching contacts 12a, 12b. Likewise disposed along switching direction 14 are proximal fixed contacts 34a, 34b opposite their respective associated switching contacts 10a, 10b.

Proximal and distal fixed contacts 34, 36 are located with respect to switching direction 14 on oppositely disposed sides of respective fixed-contact arrangement 28, 30. A fixed contact 34 can be structurally united with a fixed contact 36, resulting in a monolithic configuration.

A proximal fixed contact 34 can overlap a distal fixed contact 36, a switching contact 10, and an auxiliary switching contact 12 along switching direction 14. Accordingly, contacts 10a, 34a, 36a, 12a and contacts 10b, 34b, 36b, 12b, respectively, can be arranged in alignment along the switching direction.

In FIG. 1, two fixed-contact assemblies 28, 30 are each provided with a different number of differently configured fixed contacts 34, 36. For example, in FIG. 1, first fixed-contact arrangement 28 comprises two proximal and three distal fixed contacts 34, 36, and second fixed-contact arrangement 30 comprises three proximal and three distal fixed contacts 34, 36, wherein fixed contacts 34, 36 of second fixed-contact arrangement 30 are each smaller than fixed contacts 34, 36 of first fixed-contact arrangement 28. This configuration is merely by way of example. Both fixed-contact assemblies 28, 30 can also be configured to be identical, for example, each comprising either two or three pairs of proximal and distal fixed contacts 34, 36.

The first and/or second fixed-contact arrangement 28, 30 can each comprise one or several spring arms 38, wherein each spring arm 38 can comprise, in particular at its free end, a pair and in particular exactly one pair composed of a proximal and a distal fixed contact 34, 36. Each spring arm 38 is resiliently deflectable along switching direction 14.

If a fixed-contact arrangement 28, 30 comprises several spring arms 38, then they can be aligned parallel to one another. A gap exists between spring arms 38 of a spring arrangement 28, 30 so that spring arms 38 can be deflected independently of one another. Spring arms 38 can extend parallel or transverse to longitudinal direction 8.

The at least one spring arm 38 can be constructed to have one or several layers.

A single-layer spring arm consists of a material having high electrical conductivity, sufficient fatigue strength, and sufficient spring resilience, for example, a copper or aluminum alloy.

If spring arm 38 is multi-layered, it comprises at least two layers 40, 42 that lie one above the other along or transverse to switching direction 14.

Layers 40, 42 can each be made of different materials or of the same material but which is processed differently.

Two layers 40, 42 can fulfill different functions. For example, a first layer 40 can serve as a conductor and a second layer as a spring, in particular as a leaf spring. In such a configuration, first layer 40 is supported or held by second layer 42. First layer 40 can be formed from a material consisting of or containing copper. The second layer can be formed, for example, from spring steel or from a material consisting of or containing chromium and/or nickel.

A spring arm 38 can have a decoupling structure 44, for example, in the form of an arc or a kink, at which the two layers are not connected to one another. To keep the electrical resistance low, the cross-section of first layer 40 should remain uniform across the decoupling structure. Decoupling structure 40 modifies, in particular reduces, the spring rate of first layer 40 such that the overall spring rate of a spring arm is substantially determined only by second layer 42. If each spring arm 38 carries only one pair of contacts 34, 36, each of these contact pairs can be deflected independently of the other contact pairs along the switching direction.

First fixed-contact arrangement 28 is spaced in longitudinal direction 8 opposite second fixed-contact arrangement 30. Spring arms 38 extend from outside the space region arranged along the switching direction between two contact bridges 4, 6 into this space region.

Contact bridge arrangement 1 furthermore comprises a yoke structure 50 that extends along the switching direction behind first or second contact bridge 4, 6 so that the first or second contact bridge is enclosed at least in sections by yoke structure 50 along the switching direction, at least at its ends disposed in longitudinal direction 8.

In particular, yoke structure 50 can have two partial structures 52, 54, wherein first partial structure 52 connects first fixed-contact arrangement 28 to a terminal 32 and the second partial structure connects second fixed-contact arrangement 30 to another terminal 32. The partial structures can be formed by a busbar with two legs 56, 58, which are in particular parallel to one another. Two legs 56, 58 can extend parallel to longitudinal direction 8. Two legs 56, 58 of a partial structure 52, 54 can be connected by a further leg 60, 62, which extends along switching direction 14. Overall, two partial structures 52, 54 can result in an approximately C-or U-like shape.

In FIG. 1, contact arrangement 1 is illustrated in an open position 64 in which all contacts 10, 36, 34, 12 are spaced from one another. A circuit between two terminals 32 is therefore open.

To transition switching device 1 to a closed position, drive system 20 is actuated. First contact bridge 4 is thereafter moved in switching direction 14 against two fixed-contact assemblies 28, 30. Drive force 66 of drive system 18 is sufficient to deflect spring arms 38 in the direction of second contact bridge 6 against the force of return spring 23 until fixed contacts 36 move against auxiliary switching contacts 12. Once contacts 10, 36, 34, 12 touch, the circuit is closed. After contacts 10, 36, 34, 12 have contacted, drive system 18 moves plunger 22 onward while overtravel spring 24 is deformed, to generate a predefined contact force with which contacts 10, 36, 34, 12 are pressed against one another.

In closed position 74, the current path illustrated schematically by arrows 68 is created by first switching contact 10a and second switching contact 10b. Current path 68 comprises two parallel branches 68a, 68b in which the current flows in the same direction and parallel to one another.

This current path 68 generates a magnetic field which, should a short circuit occur between terminals 32, compensates at least in part for the repulsion force that then develops and that pushes contacts 8, 36, 34, 12 away from one another. Drive force 66 to be applied by drive system 18 can therefore be configured to be somewhat lesser because, in the event of a short circuit, lesser forces act against the drive force 66.

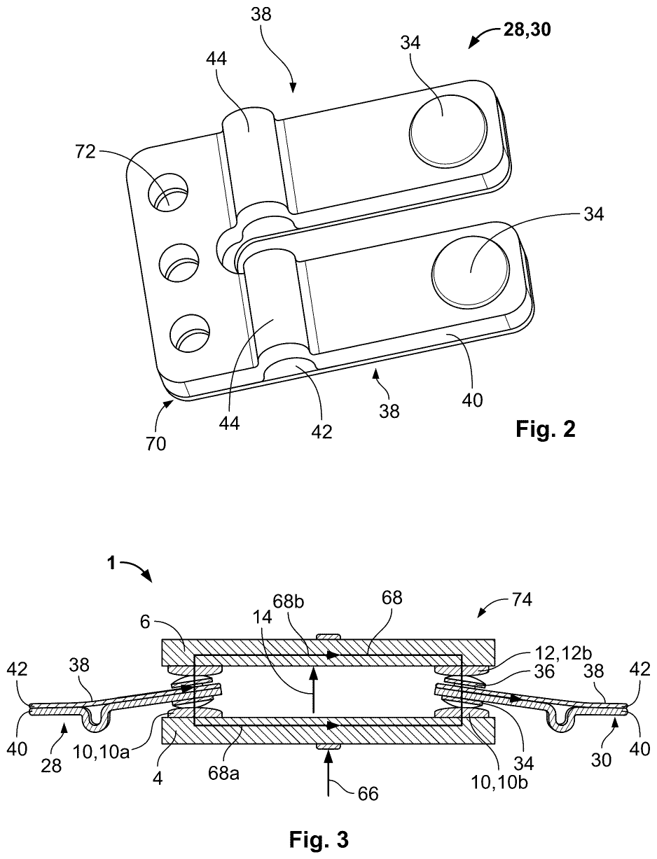

FIG. 2 shows a solid state contact arrangement 28, 30, such as can be employed in contact arrangement 1 of FIG. 1. The solid-state contact arrangement forms a single structural unit and presently has two parallel spring arms 38 extending away from a common base 70. Base 70 is rigidly fixed to the housing in contact-back arrangement 1 and is attached, for example, to a busbar which can form a partial structure 52, 54. Layer 40 with the lowest electrical resistance then abuts the busbar. Two spring arms 38 are deflectable independently of one another and can thus compensate for positional tolerances of contact bridges 4, 6. Two layers 40, 42 can extend integrally over the entire fixed-contact arrangement, with the formation of arms 38.

Provided at base 70 can be devices 72 for fastening the fixed-contact arrangement, such as through-holes for rivets or screws.

FIG. 3 shows contact arrangement 1 in closed position 74 in which drive force 66 presses switching contacts 10, fixed contacts 34, 36, and auxiliary switching contacts 12 against one another. Spring arms 38 of fixed-contact assemblies 28, 30 are resiliently deflected along switching direction 14.

When the drive system is switched off, return spring 23 moves contact arrangement 1 back to open position 64.

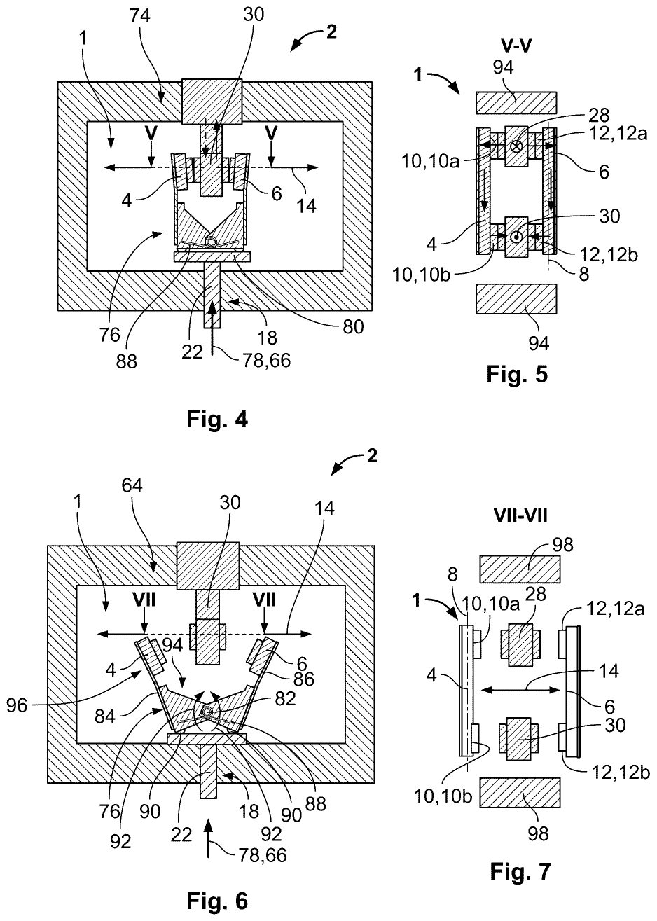

One is shown in FIGS. 4 to 7 by way of example, what a configuration of contact arrangement 1 or switching device 2 could look like in which first contact bridge 4 as well as second contact bridge 6 are driven jointly by drive system 18 along switching direction 14. Contact arrangement 1 comprises a drive mechanism 76 which is actuated by drive system 18, for example, by plunger 22, to move contact arrangement 1 from closed position 74 shown in FIGS. 4 and 5 to open position 64 shown in FIGS. 6 and 7. Drive mechanism 76 there converts a drive motion 78 of the plunger into a simultaneous motion of two contact bridges 4, 6 along switching direction 14. In the configuration presently shown, switching direction 14 is perpendicular to the direction of drive motion 78. In other configurations of drive mechanism 76, drive motion 78 and switching direction 14 can also be parallel to one another.

In the configuration shown in FIGS. 4 to 7, auxiliary switching contacts 12, like switching contacts 10, are spaced from one another in longitudinal direction 8. Contact bridges 4 and 6 therefore extend parallel to one another, at least in closed position 74, but presently also in open position 64. Furthermore, like in the previous configuration, first contact bridge 4 extends directly and in a straight line throughout in longitudinal direction 8 from first switching contact 10a to second switching contact 10b. Like in the previous configuration, second contact bridge 6 likewise extends directly and in a straight line throughout in longitudinal direction 8 from first auxiliary switching contact 12a to second auxiliary switching contact 12b. Like in the previous configuration, such a parallel arrangement of the first and the second contact bridge 4 and 6 in closed position 74 allows for the formation of two straight and therefore short branches of the current path extending parallel to one another.

Plunger 22 terminates, for example, in a ram 80 which jointly drives two levers 84 and 86 that are pivotable about a common axis 82, presently shown by way of example. First contact bridge 4 is disposed on one lever 84 and second contact bridge 6 is disposed on other lever 86. A spring element 88 biases both levers 84 and 86, for example, to open position 64, so that contact arrangement 1 assumes the open position in a state when no force is applied. Spring element 88 can be provided instead of or in addition to return spring 23.

Axis 82 is presently fixed relative to the housing. The one end of levers 84 and 86 moves transverse to switching direction 14 on rollers or slide surfaces 90 along ram 88 when the latter moves along switching direction 78. This transverse motion causes two levers 84 and 86 to undergo a flap motion about axis 82, thereby moving contact bridges 4 and 6 toward or away from one another.

Drive mechanism 76 thus converts drive force 66 into a flap moment 92 which counteracts the effect of spring element 88 so that two contact bridges 4, 6 pivot toward two fixed-contact assemblies 28, 30 arranged between them.

Levers 84, 86 can be configured at least in section as spring arms, thus fulfilling the function of an overtravel spring. At least one of levers 84, 86 can comprise, for example, two leg-shaped partial regions 94, 96 that are aligned approximately perpendicular to one another. One partial region 96 carries contact bridge 4, 6 and can form the spring arm. In closed position 74, this lever extends approximately perpendicular to switching direction 14. Other partial region 94 extends approximately parallel to switching direction 14, at least in the closed position of the configuration illustrated. It primarily serves to provide the lever force to axis 82 necessary for creating flap moment 92.

In this configuration, fixed-contact assemblies 28, 30 do not necessarily have to be configured to be resilient, as long as the motion of switching contacts 10 and auxiliary switching contacts 12 from the open to the closed position is sufficiently symmetrical. In the configuration illustrated, positional deviations can be compensated for by resilient partial regions 94 and 96.

FIGS. 5 and 7 further show that contact arrangement 1 and switching device 2, respectively, can comprise blow magnets 98 that generate a magnetic field directed to be transverse to switching direction 14.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Contact bridge arrangement for a switching device, wherein the contact bridge arrangement comprises:
a first contact bridge including a section for connecting to a drive system, a first switching contact and a second switching contact, wherein the first switching contact and the second switching contact are spaced from one another, and wherein the first contact bridge is movable along a switching direction between an open position and a closed position;
a second contact bridge including comprises a first auxiliary switching contact and a second auxiliary switching contact, wherein the first auxiliary switching contact and the second auxiliary switching contact are spaced from one another;
a first fixed-contact arrangement disposed in the switching direction between the first and the second contact bridge, the first fixed-contact arrangement including a proximal fixed contact for contacting the first switching contact as well as a distal fixed contact for contacting the first auxiliary switching contact;
a second fixed-contact arrangement disposed in the switching direction between the first and the second contact bridge, the second fixed-contact arrangement including a proximal fixed contact for contacting the second switching contact as well as a distal fixed contact for contacting the second auxiliary switching contact;
wherein, in the open position, the first switching contact is disengaged from the proximal fixed contact of the first fixed-contact arrangement, the distal fixed contact of the first fixed-contact arrangement is disengaged from the first auxiliary switching contact, the second switching contact is disengaged from the proximal fixed contact of the second fixed-contact arrangement, and the distal fixed contact of the second fixed-contact arrangement is disengaged from the second auxiliary switching contact; and
wherein, in the closed position, the first switching contact abuts the proximal fixed contact of the first fixed-contact arrangement, the distal fixed contact of the first fixed-contact arrangement abuts the first auxiliary switching contact, the second switching contact abuts the proximal fixed contact of the second fixed-contact arrangement, and the distal fixed contact of the second fixed-contact arrangement abuts the second auxiliary switching contact.

2. Contact bridge arrangement according to claim 1,
wherein, at least in the closed position,
the first switching contact and the first auxiliary switching contact are arranged in alignment with one another in the switching direction and/or
the second switching contact and the second auxiliary switching contact are arranged in alignment with one another in the switching direction.

3. Contact bridge arrangement according to claim 1,
wherein the first contact bridge and the second contact bridge extend parallel to one another, at least in the closed position.

4. Contact bridge arrangement according to claim 1,
wherein the first contact bridge extends in a straight line from the first to the second switching contact and/or the second contact bridge extends in a straight line from the first to the second auxiliary switching contact.

5. Contact bridge arrangement according to claim 1,
wherein the contact bridge arrangement in the closed position comprises a continuous current path with
a first branch extending from the first switching contact through the first contact bridge to the second switching contact; and
a second branch extending from the first auxiliary switching contact through the second contact bridge to the second auxiliary switching contact,
wherein the first branch and the second branch extend parallel to one another and in the same direction.

6. Contact bridge arrangement according to claim 1,
wherein the first fixed-contact arrangement and the second fixed-contact arrangement are formed by two separate components spaced from one another transverse to the switching direction.

7. Contact bridge arrangement according to claim 1,
wherein the first fixed-contact arrangement and/or the second fixed-contact arrangement comprises a resiliently deflectable spring arm,
and wherein the proximal fixed contact and the distal fixed contact of the respective first or second contact arrangement are arranged at the spring arm.

8. Contact bridge arrangement according to claim 7,
wherein the spring arm is resiliently deflected in the closed position along the switching direction relative to the open position.

9. Contact bridge arrangement according to claim 7,
wherein the spring arm is constructed to be multilayered.

10. Contact bridge arrangement according to claim 7,
wherein the first fixed-contact arrangement and/or the second fixed-contact arrangement comprises at least one further spring arm,
wherein at least one further proximal fixed contact and at least one further distal fixed contact of the respective first or second fixed-contact arrangement is arranged at the at least one further spring arm.

11. Contact bridge arrangement according to claim 1,
wherein the second contact bridge is attached in a stationary manner or arranged to be movable along the switching direction.

12. Switching device comprising:
a drive system and a contact bridge arrangement
the contact bridge arrangement including a first contact bridge including a section for connecting to a drive system, a first switching contact and a second switching contact, wherein the first switching contact and the second switching contact are spaced from one another, and wherein the first contact bridge is movable along a switching direction between an open position and a closed position;
the contact bridge arrangement including a second contact bridge including comprises a first auxiliary switching contact and a second auxiliary switching contact, wherein the first auxiliary switching contact and the second auxiliary switching contact are spaced from one another;
the contact bridge arrangement including a first fixed-contact arrangement disposed in the switching direction between the first and the second contact bridge, the first fixed-contact arrangement including a proximal fixed contact for contacting the first switching contact as well as a distal fixed contact for contacting the first auxiliary switching contact;
the contact bridge arrangement including a second fixed-contact arrangement disposed in the switching direction between the first and the second contact bridge, the second fixed-contact arrangement including a proximal fixed contact for contacting the second switching contact as well as a distal fixed contact for contacting the second auxiliary switching contact;
the drive system connected to the first contact bridge and configured to move the first contact bridge along the switching direction between the open position and the closed position;
wherein, in the open position, the first switching contact is disengaged from the proximal fixed contact of the first fixed-contact arrangement, the distal fixed contact of the first fixed-contact arrangement is disengaged from the first auxiliary switching contact, the second switching contact is disengaged from the proximal fixed contact of the second fixed-contact arrangement, and the distal fixed contact of the second fixed-contact arrangement is disengaged from the second auxiliary switching contact; and
wherein, in the closed position, the first switching contact abuts the proximal fixed contact of the first fixed-contact arrangement, the distal fixed contact of the first fixed-contact arrangement abuts the first auxiliary switching contact, the second switching contact abuts the proximal fixed contact of the second fixed-contact arrangement, and the distal fixed contact of the second fixed-contact arrangement abuts the second auxiliary switching contact.

13. Switching device according to claim 12, wherein the drive system is connected to the second contact bridge and configured to move the second contact bridge along the switching direction between the open position and the closed position.

14. Switching device according to claim 12, wherein the direction of motion of the first contact bridge from the open position to the closed position is opposite to the direction of motion of the second contact bridge from the open position to the closed position.

15. Switching device according to claim 14, wherein the drive system comprises an overtravel spring for both the first contact bridge as well as for the second contact bridge.

16. Switching device according to claim 12,
wherein, at least in the closed position,
the first switching contact and the first auxiliary switching contact are arranged in alignment with one another in the switching direction and/or
the second switching contact and the second auxiliary switching contact are arranged in alignment with one another in the switching direction.

17. Switching device according to claim 12,
wherein the first contact bridge and the second contact bridge extend parallel to one another, at least in the closed position.

18. Switching device according to claim 12,
wherein the first contact bridge extends in a straight line from the first to the second switching contact and/or the second contact bridge extends in a straight line from the first to the second auxiliary switching contact.

19. Switching device according to claim 12,
wherein the contact bridge arrangement in the closed position comprises a continuous current path with
a first branch extending from the first switching contact through the first contact bridge to the second switching contact; and
a second branch extending from the first auxiliary switching contact through the second contact bridge to the second auxiliary switching contact,
wherein the first branch and the second branch extend parallel to one another and in the same direction.

20. Switching device according to claim 12,
wherein the first fixed-contact arrangement and the second fixed-contact arrangement are formed by two separate components spaced from one another transverse to the switching direction.
